(19) United States
(12) Patent Application Publication
(10) Pub. No.: US 2026/0265563 A1
(43) Pub. Date: Sep. 10, 2026

(54) INK COMPRISING SILVER NANOWIRES

(71) Applicant: GENES'INK, Rousset (FR)

(72) Inventors: Stéphanie LIMAGE, LA BOUILLADISSE (FR); Benjamin DHUIEGE, BELCODENE (FR); Louis-Dominique KAUFFMANN, AIX EN PROVENCE (FR); Corinne VERSINI, AIX EN PROVENCE (FR); Nicolas OLIVE, ISTRES (FR); Virginie EL QACEMI, ROQUEVAIRE (FR)

(21) Appl. No.: 18/847,450

(22) PCT Filed: Mar. 8, 2023
(86) PCT No.: PCT/EP2023/055886

§ 371 Date: Sep. 16, 2024

(30) Foreign Application Priority Data
Mar. 16, 2022 (FR) FR2202323

(51) Int. Cl. C09D 11/52; B41M 1/12; B41M 1/26; B41M 3/00; C09D 11/033; C09D 11/037; C09D 11/14; H01B 1/22; H01B 13/34

(52) U.S. Cl. CPC C09D 11/52; C09D 11/033; C09D 11/037; C09D 11/14; H01B 1/22; H01B 13/34; B41M 1/12; B41M 1/26; B41M 3/003; B41M 3/006

(57) ABSTRACT

Ink formulations based on silver nanowires. In particular, the ink formulations based on silver nanowires, said inks being stable, transparent and having improved conductivity. The ink formulations may include at least 0.1% by weight silver nanowires, at least 0.75% by weight monohydric alcohol with 1 to 4 carbon atoms, at least 2% by weight hydroxypropyl methylcellulose, at least 20% by weight water, at least 20% by weight ethylene glycol, and at least 10% by weight propylene glycol propyl ether.

### FIELD OF THE INVENTION

The present invention relates to ink formulations based on silver nanowires. In particular, the present invention relates to ink formulations based on silver nanowires, said inks being stable, transparent and having improved conductivity. The present invention also relates to the utilization of the claimed silver nanowire-based ink for fabricating transparent conductive elements by additive manufacturing, in particular by screen printing; as well as fabricating transparent conductive electrodes from this claimed silver nanowire-based ink.

### BACKGROUND

Transparent conductive films (which will be referred to as “TCF” in the following description) are used in a wide range of products, such as liquid crystal displays (“LCDs”), touch screens (telephones, tablets, Global Positioning Systems (designated by the abbreviation “GPS”), . . . ), organic light-emitting diodes or “OLEDs” (usually referred to by its English acronym “OLED”, for organic light-emitting diode) for lighting, photovoltaics (both organic and silicon) and optics. These TCFs are highly attractive, given the huge markets for the products in which they are incorporated. This TCF market is mainly occupied by indium-tin oxide (known by the English acronym “ITO”, for “Indium Tin Oxide”), because ITO enables very good sheet resistance—or so-called “resistance carrée” in French—(as low as 10Ω/□) to be achieved, as well as very high transparency, which are two important criteria for TCFs. However, ITO has two drawbacks: 1) ITO films are not very flexible, and sheet resistance sharply increases with the radius of curvature, making them unsuitable for flexible applications; and 2) indium, one of the three constituents of ITO, is a substance for which there are no reserves as such, but which is extracted as a by-product of zinc mining (in very small quantities). What's more, none of the top 3 indium-producing countries are European (China, Canada and Japan represent around 75% of world production). It has therefore been identified as one of the 14 key raw materials by the European Union.

In this context of alternatives to ITO, the applicant has developed conductive and transparent inks that can advantageously replace existing technologies while providing other advantages that will be listed in the present description. These inks could advantageously be used as transparent electrodes and/or heating circuits in markets such as 5G smartphones, “wearables” (an English acronym for which the French academy has not yet found a synonym in the French language, and which we will translate as “connected objects that can be worn”); among the claimed inks, some (in particular those comprising metal oxide nanoparticles) have also been designed and developed to improve the manufacturing costs of transparent conductive layers (for charge transport—for example “ETL” for “ElectronTransportLayer” and/or “HTL” for “HoleTransportLayer”), for example for the organic photovoltaics ((usually referred to by its English acronym “OPV”, for “Organic Photovoltaics”), OLED, flat panel displays and optics markets. In addition, and this constitutes one embodiment of the present invention, the claimed ink is particularly suitable for use in the field of screen printing, enabling a transparent conductive design to be printed directly by additive manufacturing.

A Chinese patent application CN107365529 (A) claims a conductive ink characterized in that it comprises in percent by weight: 5-50% nanosilver wire dispersion, 0.1-5% conductive polymer, 0.01-0.5% silane coupling agent, 0.1-5% viscosity modifier, 5-40% organic solvent, 5-40% deionized water, 0.1-5% polymer resin, 0.1-5% pH regulator, 0.1-0.5% non-ionic surfactant, 0.01-0.5% wetting and dispersing agent, 0.01-0.5% leveling agent, 0.01-0.5% anti-foaming agent, and 0.01-1% metal nanoparticles; useful for the preparation of reel-to-reel conductive film.

### SUMMARY

The present invention relates to an ink comprising, as main compounds, at least 0.1% by weight of silver nanowires, at least 0.75% by weight of monohydric alcohol having from 1 to 4 carbon atoms, preferably isopropyl alcohol, at least 2% by weight hydroxypropyl methylcellulose, at least 20% by weight water, at least 20% by weight ethylene glycol, and at least 10% by weight propylene glycol propyl ether. The sum of the main compounds representing at least 60% by weight of the ink. According to a one embodiment of the present invention, the sum of the main ink compounds represents at least 65% by weight of the claimed ink, for example at least 75% by weight, preferably at least 90% by weight of the ink.

The present invention also relates to a fabrication of transparent conductive elements based on the ink by screen printing and transparent conductive elements fabricated according thereto.

### BRIEF DESCRIPTION OF THE DRAWINGS

FIG. 1 illustrates deposits of ink according to example 2 and a comparative example.

### DETAILED DESCRIPTION

### Ink

The present invention relates to an ink comprising as main compounds:
a. at least 0.1% by weight of silver nanowires,
b. at least 0.75% by weight of monohydric alcohol having from 1 to 4 carbon atoms, preferably isopropyl alcohol,
c. at least 2% by weight hydroxypropyl methylcellulose,
d. at least 20% by weight water,
e. at least 20% by weight ethylene glycol, and
f. at least 10% by weight propylene glycol propyl ether,
   the sum of the main compounds representing at least 60% by weight of the ink.

According to a one embodiment of the present invention, the sum of the main ink compounds represents at least 65% by weight of the claimed ink, for example at least 75% by weight, preferably at least 90% by weight of the ink.

The development of this ink formulation has encountered numerous technical problems, among which mention will be made for illustration purposes of foam formation and drying. In fact, it was neither the selection of solvents nor the selection of an anti-foaming agent that led to the optimum formulation as claimed, but rather the combination of the selection of all the main compounds with their claimed contents.

Thus, and this constitutes one embodiment of the present invention, the ink formulation is also characterized in that the weight ratio between water and ethylene glycol ((water)/(ethylene glycol)) is between 0.5 and 2, for example between 0.8 and 1.2.

Thus, and this constitutes one embodiment of the present invention, the ink formulation is also characterized in that the weight ratio between ethylene glycol and propylene glycol propyl ether ((ethylene glycol)/(propylene glycol propyl ether)) is between 0.5 and 2, for example between 1.0 and 1.8.

### Ink Viscosity

According to one embodiment of the present invention, the viscosity of the ink measured at a shear rate of 40 s⁻¹ and at 20° C. is between 100 and 50,000 mPa·s, preferably between 200 and 10,000 mPa·s, for example between 400 and 2,000 mPa·s.

Viscosity can be measured by any suitable method. By way of example, it can advantageously be measured using the following method:
Machine: AR-G2 rheometer from TA Instrument
Conditioning time: Pre-shear at 100 s⁻¹ for 3 minutes/equilibration for 1 minute
Test type: Shear steps
Stages: 10 s⁻¹, 40 s⁻¹, 100 s⁻¹ and 1000 s⁻¹
Step duration: 5 minutes
Mode: linear
Measurement: every 10 seconds
Temperature: 20° C.
Curve reprocessing method: Newtonian
Processed area: entire curve.

### Silver Nanowires

The ink according to the present invention comprises at least 0.1% by weight of silver nanowires. Any type of silver nanowire may advantageously be used in the context of the present invention. The concentration of said silver nanowires in the ink is advantageously limited to 2% by weight of the ink; according to one embodiment of the present invention, the concentration of silver nanowires in the ink is between 0.15% and 1% by weight. More particularly, silver nanowires with an average nanowire length of between 5 and 50 μm, preferably between 10 and 30 μm and/or an average nanoparticle diameter of between 15 and 60 nm, preferably between 20 and 40 nm, are preferred.

Nanowire size characterization can be carried out by any suitable method. The following method is mentioned for illustration purposes: images taken by microscope, in particular by means of a Field Emission Scanning Electron Microscope (FE-SEM)—measurements carried out in ultra-high-resolution mode (FoV=50 μm), at an electron energy of 10 keV and various magnifications ranging from 7,000 times to 350,000 times. An average is performed on several nanowires representing the majority of nanowires, e.g. 30 nanowires, enabling an average nanowire length and/or diameter to be established.

The silver nanowires which may be preferred for the purposes of the present invention are generally available in the form of dispersions in solvents such as isopropyl alcohol (which we shall refer to as “IPA” in the present description) and/or water; the concentration of these silver nanowires in their solvent(s) will preferably be greater than 0.5% by weight, for example greater than 0.8% by weight (nanowire weight/(solvent weight+nanowire weight)).

### Monohydric Alcohol

The ink according to the present invention comprises at least 0.75% by weight of monohydric alcohol having from 1 to 4 carbon atoms. This alcohol will advantageously be selected from aliphatic monohydric alcohols, for example selected from the group consisting of methanol, ethanol, propanol and butanol, and/or a mixture of two or more of said aliphatic monohydric alcohols; isopropyl alcohol being the preferred alcohol.

The concentration of monohydric alcohol in the ink is advantageously limited to 5% by weight of the ink; according to one embodiment of the present invention, the concentration of monohydric alcohol in the ink is between 1% and 2% by weight.

### HPMC

The ink according to the present invention comprises at least 2% by weight of hydroxypropyl methylcellulose (“HPMC”). The concentration of HPMC in the ink is advantageously limited to 4% by weight of the ink; according to one embodiment of the present invention, the HPMC concentration in the ink is between 2.5% and 3.5% by weight.

Hydroxypropyl methylcellulose, also known as hypromellose, is an inert, viscoelastic cellulose ether. It is well known and widely used in the pharmaceutical, alimentary (E464) and construction industries.

The hydroxypropyl methylcellulose that may be preferred in the context of the present invention possesses the following characteristics:
HPMC methoxy group content of between 20 and 40% by weight, preferably between 27 and 30% by weight, and/or
HPMC hydroxypropoxy group content of between 5 and 15% by weight, preferably between 7 and 12% by weight.

The hydroxypropyl methylcellulose which may be preferred in the context of the present invention is generally available in the form of a solution in water. One would preferably use a solution with a content of 5 to 20% by weight of hydroxypropyl methylcellulose in water—for example of the order of 12% by weight in water; the viscosity measured at a shear rate of 40 s⁻¹ and at 20° C. of the solution of hydroxypropyl methylcellulose in water (at 12% by weight) will preferably be between 20 and 50 Pa·s at 20° C., for example between 25 and 35 Pa·s at 20° C.

### Water

The ink according to the present invention comprises at least 20% by weight of water. The concentration of water in the ink is advantageously limited to 50% by weight of the ink; according to one embodiment of the present invention, the concentration of water in the ink is between 30% and 40% by weight.

### Ethylene Glycol

The ink according to the present invention comprises at least 20% by weight of ethylene glycol. The concentration of ethylene glycol in the ink is advantageously limited to 50% by weight of the ink; according to one embodiment of the present invention, the concentration of ethylene glycol in the ink is between 30% and 40% by weight.

Ethylene glycol, also known as glycol or ethane-1,2-diol, is mainly used as an antifreeze, coolant and reagent in (petro)chemistry.

Although ink compositions according to the present invention may comprise other polyols, either as a replacement for ethylene glycol (which is not recommended), or as a complement to the latter (as an optional compound), the applicant has found that ethylene glycol should be preferred to optimally respond to the technical problems and objectives required (e.g. drying, foaming, conductivity, . . . ).

Preferred polyols are those with a boiling point below 260° C. Examples that will be mentioned include glycols such as propylene glycol, diethylene glycol, trimethylene glycol, 1,3-butylene glycol, 1,2-butylene glycol, 2,3-butylene glycol, pentamethylene glycol, hexylene glycol, . . . , and/or a mixture of two or more of the aforementioned compounds.

According to one embodiment of the present invention, if the ink compositions comprise, in addition to ethylene glycol, other polyols (optional compounds used), it is advantageously ensured that the ratio of the total weight of said optional polyols in the ink composition divided by the weight of the ethylene glycol in the ink composition is less than 50%, for example less than 30%, or even less than 10%.

### Propylene Glycol Propyl Ether

The ink according to the present invention comprises at least 10% by weight of propylene glycol propyl ether. The concentration of propylene glycol propyl ether in the ink is advantageously limited to 40% by weight of the ink; according to one embodiment of the present invention, the concentration of propylene glycol propyl ether in the ink is between 20% and 35% by weight. Dowanol PNP (“Propylene glycol propyl ether”) has been advantageously used in the examples.

Although the ink compositions according to the present invention can comprise other polyol ethers, either as a replacement for propylene glycol propyl ether (which is not recommended), or as a complement to the latter (as an optional compound), the applicant has found that propylene glycol propyl ether should be preferred in order to optimally respond to the technical problems and objectives required (e.g. drying, foaming, conductivity, . . . ).

Preferred polyol ethers are those with a boiling point below 260° C. Examples that will be mentioned include glycol ethers, such as glycol monoethers or diethers, among which will be mentioned ethylene glycol propyl ether, ethylene glycol butyl ether, ethylene glycol phenyl ether, propylene glycol phenyl ether, diethylene glycol methyl ether, diethylene glycol ethyl ether, diethylene glycol propyl ether, diethylene glycol butyl ether (butyl carbitol), propylene glycol methyl ether, propylene glycol butyl ether, ethylene glycol dimethyl ether, ethylene glycol diethyl ether, ethylene glycol dibutyl ether, glymes, diethylene glycol diethyl ether, dibutylene glycol diethyl ether, dipropylene glycol monomethyl ether, diglymes, ethyl diglyme, butyl diglyme), and/or glycol ether acetates (for example, 2-butoxyethyl acetate, diethylene glycol monoethyl ether acetate, diethylene glycol butyl ether acetate, propylene glycol methyl ether acetate), and/or a mixture of two or more of the aforementioned compounds.

According to one embodiment of the present invention, if the ink compositions comprise, in addition to propylene glycol propyl ether, other polyol ethers (optional compounds used), it is advantageously ensured that the ratio of the total weight of said optional polyol ethers in the ink composition divided by the weight of propylene glycol propyl ether in the ink composition is less than 50%, for example less than 30%, or even less than 10%; if dipropylene glycol monomethyl ether is present, the ratio of its weight divided by the weight of propylene glycol propyl ether in the ink composition is advantageously less than 10%, for example less than 5%, less than 1% or even less than 0.1%.

### Optional Compounds

According to one embodiment of the present invention, the claimed ink may comprise up to 35% by weight of optional compounds as defined below. Among these optional compounds, mention will be made for illustration purposes of:
an alcohol different from that already used as the main compound above in the ink and chosen from monohydric alcohols having from 1 to 4 carbon atoms,
an antioxidant,
an adhesion promoter,
an anti-foaming agent,
a leveling agent,
a compound consisting of metal oxide nanoparticles, and/or
a pigment and/or dye.

According to one embodiment of the present invention, the sum of the main and optional compounds represents at least 95% by weight of the claimed ink, for example at least 99% by weight, preferably the entire ink.

### Optional Alcohol

We advantageously ensure that the ratio of the weight of the optional alcohol compound in the ink composition divided by the weight of the main alcohol compound in the ink composition is less than 30%, for example less than 10%, or even less than 5%. The alcohol used as optional compound is, for example, chosen from aliphatic monohydric alcohols with 1 to 4 carbon atoms.

### Optional Antioxidants

According to one embodiment of the present invention, the claimed ink may comprise one or more antioxidants whose total concentration in the ink is advantageously between 0.1 and 5% by weight.

Examples of antioxidants that may be used in the claimed inks will be mentioned including:
ascorbic acid or vitamin C (E300), sodium ascorbate (E301), calcium ascorbate (E302), 5,6-di-acetyl L-ascorbic acid (E303), 6-palmityl L-ascorbic acid (E304);
citric acid (E330), sodium citrate (E331), potassium citrate (E332) and calcium citrate (E333);
tartaric acid (E334), sodium tartrate (E335), potassium tartrate (E336) and potassium tartrate (E337);
butylhydroxyanisole (E320) and butylhydroxy-toluene (E321);
octyl gallate (E311) or dodecyl gallate (E312);
sodium lactate (E325), potassium lactate (E326) or calcium lactate (E327);
lecithins (E322);
natural tocopherols (E306), synthetic α-tocopherol (E307), synthetic γ-tocopherol (E308) and synthetic δ-tocopherol (E309), the tocopherols together constituting vitamin E;
eugenol, thymol and/or cinnamaldehyde,
and also, a mixture of two or more of said antioxidants.

### Optional Adhesion Promoter

According to one embodiment of the present invention, the claimed ink may comprise one or more adhesion promoters whose total concentration in the ink is advantageously between 0.1 and 5% by weight.

Examples of adhesion promoters that may be used in the claimed inks will be mentioned including synthetic polymers, for example those selected from polyacrylics, polyvinyls, polyesters and/or polyurethanes, a silane, a siloxane, a polysiloxane, and/or a mixture of two or more of the aforementioned adhesion promoters.

Without intending to restrict our explanation, these different adhesion promoters can selectively achieve good adhesion on different types of substrates, such as polyethylene terephthalate, polyethylene naphthalate, polycarbonate, polyamide, polyimide, polyetherimide, polyurethane, polyetheretherketone, polyphenylsulfone, fluoropolymers, chloropolymers, glass, silicon, epoxy resin composites, cellulose derivatives, electrophotoactive layers and charge transport layers for electronic devices, silicone, metal and/or ITO-based coatings. Examples that will be mentioned include poly(vinylpyrrolidone-co-vinyl acetate), which provides good adhesion to polymeric substrates, cellulose derivatives, glass and metal coatings, among others.

### Optional Anti-Foaming Agents

According to one embodiment of the present invention, the claimed ink may comprise one or more anti-foaming agents (chemical additives), whose total concentration in the ink is advantageously between 0.1 and 5% by weight. Without intending to restrict this explanation, these various anti-foaming agents can be used to prevent the formation of foam or to break up foam that has already formed. Examples of anti-foaming agents which may be used in the claimed inks will be mentioned including insoluble oils (ethylene bis stearamide (EBS), kerosenes, waxes), polydimethylsiloxanes and other silicones (hydrophobic silica dispersed in silicone oil), fatty alcohols possessing a long carbon chain (>C8), fatty esters (for example stearates), polyols (polyethylene glycol and polypropylene glycol copolymers), and/or a mixture of two or more of the aforementioned anti-foaming agents.

### Optional Leveling Agents

According to one embodiment of the present invention, the claimed ink may comprise one or more leveling agents, a chemical additive, whose total concentration in the ink is advantageously between 0.1 and 5% by weight. Without intending to restrict this explanation, these various leveling agents make it possible to prevent the formation of cracks and to obtain a smooth, flat coating. These are molecules with surface-active properties, whose mode of action is to reduce the surface tension of the deposited ink. Examples of leveling agents that can be used in the claimed inks will be mentioned including silicone polyacrylates (silicone acrylate copolymers) and fluorosurfactants (surfactants comprising a perfluoroalkyl group), and/or a mixture of the said leveling agents.

Optional Pigment and/or Dye

According to one embodiment of the present invention, the claimed ink may comprise one or more pigments and/or dyes whose total concentration in the ink is advantageously between 0.1 and 5% by weight.

Dyes are natural or synthetic organic compounds, that are soluble in the medium they color. They are used in solution (often aqueous).

Pigments are usually inorganic compounds, natural or synthetic, insoluble in the medium in which they are dispersed. They provide a color that is unaffected, or only slightly affected, by the medium in which they are dispersed.

For example, pigments are white or colored particles, mineral or organic, designed to change the absorption wavelength, for example to change the coloration of the final dry ink film. As illustration, mention will be made of:
mineral pigments such titanium oxide, zirconium oxide or cerium oxide, as well as zinc oxide, iron oxide or chromium oxide, ferric blue, manganese violet, ultramarine blue and/or chromium hydrate,
inorganic pigments such as carbon black, lacquers based on cochineal carmine, barium, strontium or calcium,
organic pigments,
and/or a mixture of two or more of the aforementioned pigments.

According to one embodiment variant of the present invention, the ink may also contain nacre (for example, iridescent particles, produced by certain mollusks in their shells or synthesized), which we will refer to as nacreous pigments. As an illustration, mention will be made of white nacreous pigments such as mica coated with titanium or bismuth oxychloride, colored nacreous pigments such as titanium mica with iron oxides, titanium mica with, in particular, ferric blue or chromium oxide, titanium mica with an organic pigment of the aforementioned type, as well as nacreous pigments based on bismuth oxychloride, and/or a mixture of two or more of the aforementioned compounds.

According to one embodiment variant of the present invention, the ink may also comprise colorless or white, mineral or synthetic, lamellar or non-lamellar particles. Among which mention will be made for illustration purposes of talc, zinc stearate, mica, kaolin, polyamide powders, polyethylene powders, tetrafluoroethylene polymer powders, starch and boron nitride, polymeric microspheres such as polyvinylidene chloride/acrylonitrile, acrylic acid copolymers and silicone resin microbeads, elastomeric organopolysiloxanes, and/or a mixture of two or more of the aforementioned compounds.

According to one embodiment variant of the present invention, the ink may also comprise water-soluble or fat-soluble dyes. Among which mention will be made for illustration purposes of fat-soluble dyes such as Sudan Red, DC Red 17, DC Green 6, β-carotene, soybean oil, Sudan Brown, DC Yellow 11, DC Violet 2, DC Orange 5, quinoline yellow, water-soluble dyes such as beet juice, methylene blue, and/or a mixture of two or more of the aforementioned compounds.

### Optional Metal Oxide Nanoparticles

According to one embodiment variant of the present invention, the claimed ink may comprise metal oxide nanoparticles whose total concentration in the ink is advantageously between 0.1 and 5% by weight. As an illustration of metal oxide nanoparticles, mention will be made of zinc oxide nanoparticles and/or tungsten oxide nanoparticles, and/or a mixture of the two. Examples include tungsten oxide (WO₃) nanoparticles containing oxalic acid ligands (for example, from 5% to 15% by weight of oxalic acid ligands) and/or zinc oxide (ZnO) nanoparticles containing acetate ligands (for example, from 5% to 15% by weight of acetate ligands).

These nanoparticles can have a diverse range of shapes, among which mention will be made for illustration purposes of beads (for example from 1 to 100 nm), rods (for example of length L<200 to 300 nm), wires (for example of lengths of a few hundred nanometers or even a few microns), disks, stars, pyramids, tetrapods or crystals when they have no predefined shape.

According to one embodiment variant of the present invention, the nanoparticles have dimensions between 1 and 50 nm, preferably between 2 and 20 nm.

According to one embodiment variant of the present invention, the nanoparticles are spheroidal and/or spherical in shape. For the present invention and the following claims, the term “spheroidal in shape” means that the shape resembles that of a sphere but is not perfectly round (“quasi-spherical”), for example an ellipsoidal shape.

The size distribution of nanoparticles can be measured by any suitable method. For example, it can advantageously be measured using the following method: use of a Malvern Nanosizer S type machine with the following characteristics:
Dynamic light scattering (DLS) measurement method:
Cell type: optical glass
Material: metal oxide, for example ZnO or WO₃
Refractive index of nanoparticles: 2.008
Absorption: 0.001
Dispersant: solvent for example, methanol (for ZnO) or ethylene glycol (for WO₃)
Temperature: 20° C.
Viscosity: 0.5867 (for methanol) or 19.8316 (for ethylene glycol)
Dispersant refractive index: 1.326 (for methanol) or 1.423 (for ethylene glycol)
General Options: Mark-Houwink parameters
Analysis Model: General purpose
Equilibration: 120 s
Number of measurements: 4

D50 is the diameter at which 50% of nanoparticles by number are smaller. This value is considered representative of the average grain size.

The shape and size of nanoparticles can also advantageously be identified by means of images taken with a microscope, in particular a Transmission Electron Microscope (TEM), as described below. The measurements are carried out using a Thermofisher Scientific Transmission Electron Microscope (TEM) with the following characteristics:
Bright field (TEM-BF) images are taken at 300 kV,
With 50 μm objective diaphragm for low magnifications and without objective diaphragm for high resolution,
Dimensional measurements are performed on TEM images using Digital Micrograph software and averaged over a number of particles representative of the majority of particles, for example 20 particles, to establish an average area, an average circumference and/or an average diameter of the nanoparticles.

Thus, according to one embodiment variant of the present invention, the nanoparticles are spheroidal and are preferably characterized by means of this TEM identification by an average nanoparticle area of between 1 and 20 nm², preferably between 5 and 15 nm², and/or by an average nanoparticle circumference of between 3 and 20 nm, preferably between 5 and 15 nm, and/or by an average nanoparticle diameter of between 0.5 and 7 nm, preferably between 1 and 5 nm.

### Deposition Methods

Although any deposition method can be used for the claimed ink, for example by adapting the viscosity and/or solid content of said ink, deposition by coating or screen printing is particularly suited to it, preferably screen printing deposition.

As an illustration of screen printing deposition, mention will be made of the ATMA AT-45PA digital flatbed screen printer, which can be used to print patterns by screen printing. Screen printing is a printing technique that uses stencils (masks) interposed between the ink and the support. The supports used can be varied (paper, cardboard, textile, metal, glass, wood, etc.). To define the pattern to be printed, the material constituting the screen is blocked in certain areas so that the ink does not pass through them. To achieve this, the screen is coated with a photosensitive emulsion, and the areas where the ink must not pass through are exposed to UV light, which hardens the emulsion. The emulsion in areas not exposed to UV light is removed with water. The ink can then pass through the corresponding screen mesh. The ATMA machine is designed for printing on high-quality, flat substrates such as flexible circuits, touch screens, rigid or flexible printed circuits, and so on. For screen printing deposition, a quantity of ink is deposited on the mask, the squeegee and counter-squeegee are impregnated with ink, then the ink is automatically transferred through the mask design onto the substrate.

In particular, the screen printing deposits realized within the framework of the present invention were carried out with the following printing parameters:
Printing speed: 100 m/s
Pressure: Indicator 9
Squeegee hardness: 75 shores
Squeegee angle: 22.5°.
Screen mask properties:
   Mesh number: 230 meshes/inch
   Mesh diameter: 48 μm
   Mesh type: polyester
   Emulsion thickness: 30 μm

Then, the deposits are left to dry, for example in two stages—at room temperature for 90 seconds followed by annealing at 90° C. for 5 minutes. This was the method used to prepare the samples whose transmittance and sheet resistance properties were measured.

### Transparent Conductive Electrodes

The present invention also relates to the fabrication of transparent conductive elements based on the claimed ink by additive manufacturing, preferably by screen printing.

The present invention therefore also relates to the use of the claimed silver nanowire-based ink for the fabrication of transparent conductive elements by additive manufacturing, in particular screen printing. The present invention also relates to the said transparent conductive elements, for example transparent conductive electrodes, manufactured according to any of the uses listed above, i.e. additive manufacturing, in particular screen printing.

Any type of suitable substrate may advantageously be used for the deposition of the claimed ink. Among which mention will be made for illustration purposes of plastics such as polyesters, PET (for example Folex® films, for example Folex X-130), PC, or cellulose-based materials such as paper or nanocellulose.

The ink will advantageously be gently homogenized before use (for example manually) at room temperature for a period of time, for example 30 minutes. Optionally, the ink is gravity-filtered through a 60 μm porosity nylon filter.

As already indicated above, the preferred deposition method is the above-mentioned screen printing process.

Then, the deposits are left to dry, for example in two stages—at room temperature for 90 seconds followed by annealing at 90° C. for 5 minutes.

### Transparency

Ink transparency is represented by measuring the transmittance of a prepared sample as detailed above in the description.

According to one embodiment of the present invention, the claimed ink transparency is characterized by a sample transmittance value of between 80 and 95% at a wavelength of 550 nm. Transmittance measurement is advantageously carried out using a Varian Cary 300 UV-Visible spectrophotometer (Agilent) employing a halogen lamp and a deuterium (UV) lamp enabling measurement over a wavelength range from 200 to 800 nm (the visible range being 380 to 800 nm). The UV-Visible spectrophotometer measures the absorbance (a unitless quantity) of a sample when a beam of light passes through it. When light of intensity I₀ passes through a sample, part of it is absorbed by the sample itself. The intensity I of the transmitted light is therefore less than I₀. The absorbance of the solution is defined by the following equation

$$A = log ( \frac{{I}_{0}}{I} ) . \qquad [ Math 1 ]$$

The transmittance is defined by the relation

$$T = \frac{I}{{I}_{0}} . \qquad [ Math 2 ]$$

So,

$$A = - log T . \qquad [ Math 3 ]$$

Absorbance is a positive value with no unit. It increases as the transmitted intensity decreases. The Cary 300 spectrophotometer is a double-beam instrument, where light is split into two beams before reaching the sample. One beam is used as a reference and passes through a “blank” (the substrate in our case), while the other passes through the sample (metal coating on PET substrate). The sample and reference are positioned on a solid sample holder. The instrument alternately measures the transmitted beam of the reference sample and that of the sample being analyzed. The analysis is carried out in double beam mode, with baseline measurement beforehand and automatic baseline correction during sample measurement. The results are represented in the form of a graph showing the absorbance curve of the sample as a function of wavelength and converted into a transmittance curve using the above equation. Transmittance values in the examples described in the present invention come from measurements taken specifically at 550 nm.

### Conductivity

The ink conductivity is represented by measuring the sheet resistance of a prepared sample as detailed above in the description.

According to one embodiment of the present invention, the claimed ink conductivity is characterized by a sample sheet resistance value between 5 and 100 Ohm/□.

The sheet resistance of conductive coatings can advantageously be measured using the 4-point method. As an illustration, the equipment and software used for this method are Microworld's S302 resistivity bench coupled to an Agilent U8001A current source and an Agilent U3400 multimeter. The four-tip method works by bringing four equally spaced, collinear probes into contact with the material to be characterized. A DC current is applied to the outer probes of the measuring head, and the resulting voltage between the other two points of the head is raised. Then, the sheet resistance is calculated according to this equation:

$${R}_{S} = \frac{π}{ln ( 2 )} \frac{Δ V}{I} = 4.53236 \frac{Δ V}{I} \qquad [ Math 4 ]$$

Rs is the sheet resistance (in Ohm/□), ΔV is the voltage variation measured between the inner probes (in Volt), and I is the current applied between the outer probes (in Ampere). The coefficient 4.53236 is given in the user manual for the S302 resistivity bench and corresponds to π/ln(2)=4.53236.

### EXAMPLES

Table 1 below shows three ink compositions representative of the present invention.

TABLE 1

| % weight | Example 1 | Example 2 | Example 3 |
|---|---|---|---|
| AgNWs | 0.5 | 0.2 | 0.7 |
| IPA | 1.25 | 1.25 | 1.8 |
| Water | 32.5 | 32.5 | 35.8 |
| EG | 32.7 | 32.85 | 36 |
| Dowanol PnP | 30 | 30.15 | 22.7 |
| HPMC | 3 | 3 | 3 |
| Edaplan LA413 | 0.05 | 0.05 | / |

Percentages in the table are by weight.

The “Ag NWs” refers to silver nanowires, with the following dimensions: diameter 25±3 nm and length 13±6 μm.

The “IPA” is isopropyl alcohol, CAS number 67-63-0, from VWR, reference 84881 with a purity level of 99.9%.

The “EG” is ethylene glycol, CAS number 107-21-1, from VWR, reference 24041.297 with 100% purity.

“Dowanol™ PnP” is propylene glycol propyl ether, CAS number 1569-01-3, from DOW Inc with 99% purity.

The “HPMC” is hydroxypropyl methylcellulose used from a 12% by weight solution of HPMC, from Alfa Aesar, reference 44779, in osmosis water from VWR, reference 102928H AnalaR NormaPur Grade 3 Max. 1 μS/cm.

The “Edaplan® LA413” is a substituted polysiloxane additive from MUNZING, reference M9586, with a purity level of approx. 100%.

Table 2 below shows the characteristics of the inks and corresponding deposits.

TABLE 2

| Ink | Example 1 | Example 2 | Example 3 |
|---|---|---|---|
| Viscosity@20° C. | 1400 ± 160 | 1200 ± 60 | 1700 ± 110 |
| (cPs) | 1100 ± 120 | 1000 ± 60 | 1300 ± 80 |
| 10/40/100/ | 1000 ± 80 | 900 ± 50 | 1100 ± 60 |
| 1000 s⁻¹ | 500 ± 30 | 500 ± 20 | 500 ± 20 |
| Substrate | PET | PET | PET |
| | (polyethylene | (polyethylene | (polyethylene |
| | terephthalate) | terephthalate) | terephthalate) |
| Drying conditions | TA, 90 s + | TA, 90 s + | TA, 90 s + |
| | 90° C., 5 min | 90° C., 5 min | 90° C., 5 min |
| Deposition method | Screen printing | Screen printing | Screen printing |
| Sheet resistance | 8 ± 2 | 50 ± 5 | 16 ± 4 |
| (Ω/□) | | | |
| Transmission@550 | 84 ± 2 | 92 ± 2 | 90 ± 3 |
| nm (%) | | | |

The PET is PET Folex X-130 (polyethylene terephthalate).

For comparison, an ink formulation was prepared identically to that of Example 2 above with the ingredients selected from the prior state of art according to the Chinese patent application CN107365529 (A).

| | |
|---|---|
| Comparative Example | Example 2 |

| Composition | % | Composition | % |
|---|---|---|---|
| NWs | 0.5 | NWs | 0.2 |
| IPA | 15 | IPA | 1.25 |
| HMPC | 1.5 | HMPC | 3 |
| Water | 56.83 | Water | 32.5 |
| Glycerol | 26.17 | Ethylene Glycol | 32.9 |
| | | Dowanol PNP | 30.2 |
| | | Edaplan LA 413 | 0.05 |
| | 100.0 | | 100.0 |

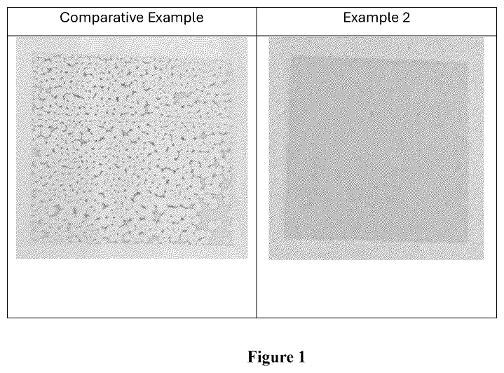

Both inks were deposited by screen printing and dried under conditions strictly identical to those mentioned in table 2 above. Observation using the images appended in FIG. 1 shows that the deposit according to the comparative example has an inhomogeneous appearance with de-wetting and foaming, whereas that of example 2 has a homogeneous appearance in line with the technical effects set out in the introduction to the present invention.

FIG. 1 is an example of how to visualize the advantages of the present invention, among which improved drying, absence of foaming and deposit homogeneity are critical to the use of screen printing inks.

1. An ink comprising, as main compounds:
a. at least 0.1% by weight silver nanowires,
b. at least 0.75% by weight monohydric alcohol with 1 to 4 carbon atoms,
c. at least 2% by weight hydroxypropyl methylcellulose,
d. at least 20% by weight water,
e. at least 20% by weight ethylene glycol, and
f. at least 10% by weight propylene glycol propyl ether,
the percentage by weight of each of the main compounds being based on a total weight of the ink, and a sum of the main compounds representing at least 60% by weight of the ink.

2. The ink according to claim 1, characterized in that a weight ratio
between water and ethylene glycol ((water)/(ethylene glycol)) is between 0.5 and 2; and/or
between ethylene glycol and propylene glycol propyl ether ((ethylene glycol)/(propylene glycol propyl ether)) is between 0.5 and 2.

3. The ink according to claim 1, characterized in that the concentration of the silver nanowires in the ink is less than or equal to 2% by weight.

4. The ink according to claim 1, characterized in that the concentration of the silver nanowires in the ink is between 0.15% and 1% by weight.

5. The ink according to claim 1, characterized in that the concentration of the monohydric alcohol in the ink is less than or equal to 5% by weight.

6. The ink according to claim 1, characterized in that the concentration of the monohydric alcohol in the ink is between 1% and 2% by weight.

7. Ink according to claim 1, characterized in that the monohydric alcohol having from 1 to 4 carbon atoms is selected from aliphatic monohydric alcohols.

8. The ink according to claim 1, characterized in that the monohydric alcohol having from 1 to 4 carbon atoms is isopropyl alcohol.

9. The ink according to claim 1, characterized in that the concentration of the hydroxypropyl methylcellulose in the ink is less than or equal to 4% by weight.

10. The ink according to claim 1, characterized in that a concentration of hydroxypropyl methylcellulose in the ink is between 2.5% and 3.5% by weight.

11. The ink according to claim 1, characterized in that the concentration of the water in the ink is less than or equal to 50% by weight.

12. The ink according to claim 1, characterized in that the concentration of the water in the ink is between 30% and 40% by weight.

13. The ink according to claim 1, characterized in that the concentration of the ethylene glycol in the ink is less than or equal to 50% by weight.

14. The ink according to claim 1, characterized in that the concentration of the ethylene glycol in the ink is between 30% and 40% by weight.

15. The ink according to claim 1, characterized in that the concentration of the propylene glycol propyl ether in the ink is less than or equal to 40% by weight.

16. The ink according to claim 1, characterized in that the concentration of the propylene glycol propyl ether in the ink is between 20% and 35% by weight.

17. The ink according to claim 1, characterized in that a viscosity of the ink measured at a shear rate of 40 s⁻¹ and at 20° C. is between 400 and 2000 mPa·s.

18. The ink according to claim 1, characterized in that the silver nanowires have an average nanowire length between 5 and 50 μm and/or an average nanoparticle diameter between 15 and 60 nm.

19. The ink according to claim 1, characterized in that the hydroxypropyl methylcellulose has a methoxy group content between 20 and 40% by weight, and/or a hydroxypropoxy group content between 5 and 15% by weight.

20. The ink according to claim 1, characterized in that the sum of the main compounds represents at least 90% by weight of the ink.

21. The ink according to claim 1, characterized in that it comprises, as additional compounds,
a. an alcohol different from that already used as the main compound above in the ink and chosen from monohydric alcohols having from 1 to 4 carbon atoms,
b. an antioxidant,
c. an adhesion promoter,
d. an anti-foaming agent,
e. a leveling agent,
f. a compound consisting of metal oxide nanoparticles, and/or
g. a pigment and/or dye,
wherein the sum of the main compounds and the additional compounds represents at least 99% by weight of the ink.

22. A method of fabricating transparent conductive elements based on the ink according to claim 1 by screen printing.

23. A transparent conductive element fabricated according to claim 22.
